(19) United States
(12) Patent Application Publication
(10) Pub. No.: US 2022/0318624 A1
(43) Pub. Date: Oct. 6, 2022

(54) ANOMALY DETECTION IN MULTIPLE OPERATIONAL MODES

(71) Applicant: NEC Laboratories America, Inc., Princeton, NJ (US)

(72) Inventors: Masanao Natsumeda, Kawasaki (JP); Wei Cheng, Princeton Junction, NJ (US); Takehiko Mizoguchi, Princeton, NJ (US); Haifeng Chen, West Windsor, NJ (US)

(21) Appl. No.: 17/676,944

(22) Filed: Feb. 22, 2022

Related U.S. Application Data
(60) Provisional application No. 63/170,675, filed on Apr. 5, 2021.

(51) Int. Cl. G06N 3/08; G06N 3/04; G06K 9/62

(52) U.S. Cl. CPC G06N 3/08; G06N 3/0454; G06K 9/6262; G06K 9/6288

(57) ABSTRACT

Methods and systems for training a neural network include training models for respective sensor groups in a cyber-physical system. Combinations of sensor groups and operational modes are sampled. A combination model is trained for each of the sampled combinations. A best combination model is determined based on performance measured during training. The best combination model is fine-tuned.

This application claims priority to U.S. Application No. 63/170,675, filed on Apr. 5, 2021, incorporated herein by reference in its entirety.

### BACKGROUND

### Technical Field

The present invention relates to automated anomaly detection, and, more particularly, to detection of anomalies in systems that have multiple operational modes.

### Description of the Related Art

Complex systems, such as in modern manufacturing industries, power plants, and information services, are difficult to monitor due to the large number of sensors that may be installed, each generating respective time series information. For example, temperature and pressure sensors may be distributed throughout a power plant. It is challenging to identify anomalous behavior across such complex systems, particularly when the system may have multiple operational modes.

### SUMMARY

A method for training a neural network includes training models for respective sensor groups in a cyber-physical system. Combinations of sensor groups and operational modes are sampled. A combination model is trained for each of the sampled combinations. A best combination model is determined based on performance measured during training. The best combination model is fine-tuned.

A method for training a neural network includes training models for respective sensor groups in a cyber-physical system, each of the models including a long-short term memory auto-encoder. Combinations of sensor groups and operational modes are sampled, with each operational mode corresponding to a different operational mode of the cyber-physical system. A combination model is trained for each of the sampled combinations using one of model merging and model decomposition. A best combination model is determined based on performance measured during training. The best combination model is fine-tuned.

A system for training a neural network includes a hardware processor and a memory that includes a computer program. When executed by the hardware processor, the computer program causes the hardware processor to train models for respective sensor groups in a cyber-physical system, to sample combinations of sensor groups and operational modes, to train a combination model for each of the sampled combinations, to determine a best combination model based on performance measured during training, and to fine-tune the best combination model.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a diagram of a cyber-physical system with an automated monitoring and maintenance system that can detect anomalous activity and perform corrective actions, in accordance with an embodiment of the present invention;

FIG. 2 is a block/flow diagram of a method of training an anomaly detection model using data from various operational modes of the cyber-physical system, in accordance with an embodiment of the present invention;

FIG. 3 is a block/flow diagram of a method for monitoring and maintaining a cyber-physical system, in accordance with an embodiment of the present invention;

FIG. 4 is a block diagram of a computing device capable of performing model training and system monitoring and maintenance, in accordance with an embodiment of the present invention;

FIG. 5 is a diagram of an exemplary neural network architecture that can be used in implementing anomaly detection, in accordance with an embodiment of the present invention; and

FIG. 6 is a diagram of an exemplary deep neural network architecture that can be used in implementing anomaly detection, in accordance with an embodiment of the present invention.

### DETAILED DESCRIPTION OF PREFERRED EMBODIMENTS

Cyber-physical systems with multiple distinct operational modes may generate distinct sets of sensor data. The systems may be monitored by sensors that produce respective sets of multivariate time series data. Machine learning models can be trained on such time series data, and these models may be used to monitor the behavior of the system. For example, the model may recognize unfamiliar sensor data and may indicate that an anomaly has occurred.

However, some systems may have multiple different operational modes. A single model that covers all of the operational modes may have a high false negative rate, and may need a large amount of training data. Alternatively, using multiple models for the different respective operational modes tends to produce a high false positive rate for rare operational modes, as there may not be sufficient training data available for the rare modes. In another alternative, models may be trained to handle different subsets of the operational modes to strike a balance between false positives and false negatives, but this may need a model for each combination of operational modes, which can incur a high computational cost.

Furthermore, certain operational modes may cause additional complications. For example, start-up and shutdown operations may include chains of events. Each event can form an operating mode. Further, not all of the system's sub-systems are necessarily active during the entire operation. Dependencies between sub-systems may change over time, and some of the sub-systems may be independent until particular operations are performed, or may become independent during an operation. Thus, a model for each group of sub-systems may be needed, but not for the entire system.

Training data with labeled anomalies may not be available. Furthermore, performance of the combinations of operating modes and sub-systems may not be possible until the corresponding models have been trained, with many potential combinations being available.

To avoid calculating models for every possible combination of operational modes, the best combination of modes can be estimated. A model may be built for each operational mode, and then combinations of the modes may be sampled. The pre-trained models may be adapted to each sampled combination and then tested for their performance on the sampled combination. The best combination of models may be determined by solving an optimization problem based on the performance for each combination. The best combination can then be used for monitoring the cyber-physical system.

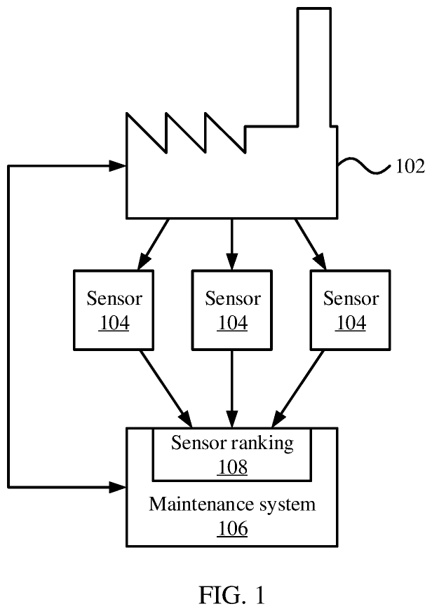

Referring now in detail to the figures in which like numerals represent the same or similar elements and initially to FIG. 1, a maintenance system 106 in the context of a monitored system 102 is shown. The monitored system 102 can be any appropriate system, including physical systems such as manufacturing lines and physical plant operations, electronic systems such as computers or other computerized devices, software systems such as operating systems and applications, and cyber-physical systems that combine physical systems with electronic systems and/or software systems. Exemplary systems 102 may include a wide range of different types, including power plants, data centers, and transportation systems.

One or more sensors 104 record information about the state of the monitored system 102. The sensors 104 can be any appropriate type of sensor including, for example, physical sensors, such as temperature, humidity, vibration, pressure, voltage, current, magnetic field, electrical field, and light sensors, and software sensors, such as logging utilities installed on a computer system to record information regarding the state and behavior of the operating system and applications running on the computer system. The information generated by the sensors 104 can be in any appropriate format and can include sensor log information generated with heterogeneous formats.

The sensors 104 may transmit the logged sensor information to an anomaly maintenance system 106 by any appropriate communications medium and protocol, including wireless and wired communications. The maintenance system 106 can, for example, identify abnormal behavior by monitoring the multivariate time series that are generated by the sensors 104. Once anomalous behavior has been detected, the maintenance system 106 communicates with a system control unit to alter one or more parameters of the monitored system 102 to correct the anomalous behavior. This action can be performed based on a sensor ranking 108, which identifies sensors 104 that are most associated with the determination of anomalous behavior.

Exemplary corrective actions include changing a security setting for an application or hardware component, changing an operational parameter of an application or hardware component (for example, an operating speed), halting and/or restarting an application, halting and/or rebooting a hardware component, changing an environmental condition, changing a network interface's status or settings, etc. The maintenance system 106 thereby automatically corrects or mitigates the anomalous behavior. By identifying the particular sensors 104 that are associated with the anomalous classification, the amount of time needed to isolate a problem can be decreased.

Each of the sensors 104 outputs a respective time series, which encodes measurements made by the sensor over time. For example, the time series may include pairs of information, with each pair including a measurement and a timestamp, representing the time at which the measurement was made. Each time series may be divided into segments, which represent measurements made by the sensor over a particular time range. Time series segments may represent any appropriate interval, such as one second, one minute, one hour, or one day. Time series segments may represent a set number of collection time points, rather than a fixed period of time, for example covering 100 measurements.

Two strategies can adapt the pre-trained models to each sampled combination, including model merging and model decomposition. These two strategies may provide different combinations of sensor groups for each operational mode. Each combination may be defined by a combination of a sensor group and an operational mode.

In model merging, pre-trained models may be concatenated with a fully connected layer. Weights may be initialized with corresponding weights from the pre-trained models, if they exist. The weights that do not correspond to weights in the pre-trained models may be initialized by any appropriate process. A model may then be trained for each sensor group to form the pre-trained models.

In model decomposition, a neural network model has components for the sensor groups and a component to combine outputs from the sensor group components. A pre-trained model may be trained using a loss term that enforces the ability to decompose the model. Components for sensor groups not included in the corresponding sampled combination may be removed during domain adaptation, and the model may be adapted to the corresponding sensor groups and the operational modes.

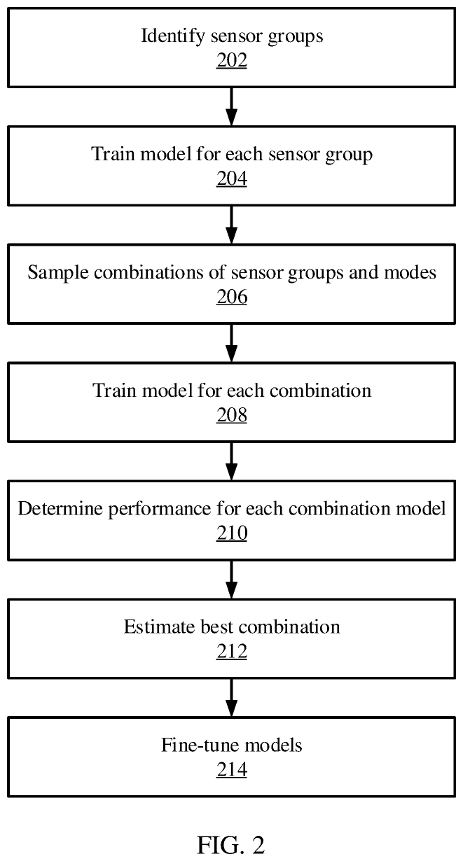

Referring now to FIG. 2, a method for training anomaly detection models is shown. An optimal set of models is generated which covers all of the sensor groups and operational modes, trained without the need for labeled training data. Block 202 identifies groups of sensors 104, for example with a list of sensor identifiers associated with each sensor group. A region (i,j) may be defined as a pair of the i^{th} sensor group and the j^{th} operational mode. Assuming that sensor groups are identical over operational modes, there are SO groups, given S sensor groups and O operational modes.

Block 204 trains a model for each respective sensor group, for example using historical time series information recorded for each of the sensors in the sensor group. At this stage, models are trained for all operational modes and all sensor groups. There may be M candidate models, with each model m generating a detection score s_{d}^{(m)}. A penalty score is represented as λ, and wᵢⱼ^{(m)}∈{0,1} is an indicator function of occupancy at the region (i,j) by the m^{th} model. A set of models is sought by minimizing the optimization function:

$${\sum }_{m = 1}^{M} {s}_{d}^{( m )} {z}^{( m )} + λ {\sum }_{m = 1}^{M} {z}^{( m )}$$

such that Σₘ₌₁^{M}wᵢⱼ^{(m)}z^{(m)}=1, where z^{(m)}∈{0,1} is an indicator function of selecting the m^{th} model as a member of the optimal set of models. This optimization problem is NP-hard, but can be approximated with a branch and bound approach if detection and penalty scores are available.

The models may be trained using training data, which may include multivariate time series information for each of the sensor groups. Thus, Xᵢ may be a multivariate time series for the i^{th} sensor group. A root model may include multiple networks, including networks of a first type and a network of a second type. The root model takes a multivariate time series as its input and each first type network takes a part of the time series corresponding to its respective sensor group. Each first type network reconstructs the full input time series as much as possible by itself. The outputs of the first type networks may be concatenated and fed into the second type network. The network of the second type improves the reconstruction, taking dependencies between sensor groups into account.

Thus, Yᵢ may be the reconstruction of the input by an i^{th} network of the first type relating to sensor group [symbol] , Y=[Y₁, . . . , Y_{S}] may be the concatenated matrices of Yᵢ, and \hat{X}=[\hat{X}₁, . . . , \hat{X}_{S}] may be the output of the network of the second type [symbol] . The outputs of the root model \hat{X} may be defined as:

\hat{X}= [symbol] (Y)

where Yᵢ= [symbol] (Xᵢ). For example, the first type of network may include long-short term memory (LSTM) autoencoders and the second type of network may include a fully connected layer without intercept terms.

The root model may be trained with a mini batch gradient descent. With K as the number of time series segments in a mini batch, X⁽ⁱ⁾ may be the i^{th} input time series segment in the mini back, Y⁽ⁱ⁾ may be values reconstructed by the networks of the first type, and \hat{X}⁽ⁱ⁾ may be the reconstructed values output by the second type of network. The reconstruction may be defined as: \hat{X}ᵢ=Pᵢ(Dᵢ(Eᵢ(Xᵢ))), where Pᵢ is the projection layer for the i^{th} sensor group, D₁ is the decoder for the i^{th} sensor group, and E₁ is the encoder for the i^{th} sensor group.

The loss function of the root model may be defined as:

$${L}_{root} = \frac{1}{K} {\sum }_{i = 1}^{K} {L}_{i} + \frac{1}{K} {\sum }_{i = 1}^{K} {G}_{i}$$

where Lᵢ=∥\hat{X}⁽ⁱ⁾−X⁽ⁱ⁾∥₂² and Gᵢ=∥Y⁽ⁱ⁾−X⁽ⁱ⁾∥₂² The first term of Lᵣₒₒₜ may be interpreted as the mean-square error (MSE) of the reconstruction by the entire model. The second term of Lᵣₒₒₜ may be interpreted as the MSE of the reconstructions of the first-type networks. This term encourages the first-type networks to maintain reasonable reconstruction performance independent of the others, enhancing reusability of the first-type networks and providing superior initial values for transfer learning through model decomposition. During training, the MSE of the reconstruction by the entire root model may be computed with validation data, and the parameters with the minimum MSE may be kept for the trained model.

Block 206 samples combinations of sensor groups and operational modes. The different operational modes may be indicated by an indication in the sensor data, for example indicating particular operational modes at different time stamps or ranges of time. Block 206 may sample all possible combinations or just a subset. In the latter case, at least one set of models may cover all sensor groups and operational modes to be mutually exclusive and collectively exhaustive. One solution is to cause the sampled combinations to always include all possible pairs of a sensor group and an operational mode. Given a number of target domains, sampling is performed without replacement from all possible combinations of operational modes and sensor groups.

Block 208 trains a model for each of the sampled combinations, using the models trained by block 204. The same number of training iterations may be used for each combination, or a different number may be used. Because the weight values in the previously trained model represent aspects of the domain of the data used for training, they may be good initial values for training at a new domain if the new domain and the domain of the previously trained model have similar aspects. This can provide faster convergence for optimization. Thus, the domain of the previously trained model may be a source domain, and the domain of the new model may be a target domain. Similarly, the previously trained model may be a source model and the new model may be a target model.

To incorporate domain adaptation and reduce training costs for each model with different combinations of operational modes and sensor groups, the model's weight values for a same sensor group may be transferrable. Different strategies for domain adaptation may be employed, such as model merging and model decomposition, described in greater detail below. Model merging trains a model for each sensor group as a source model and then trains a new model for new regions using weight values from the source models. Model decomposition trains a model for all the sensor groups as a source model, and then trains a new model for new regions.

During the training of the target model(s), root mean squared error (RMSE) may be periodically calculated, in block 210, using validation data of the corresponding regions and the model parameters with the best RMSE at the validation data being retained. After training, another performance metric for searching the best combination of models may be calculated for each model.

The RMSE can be calculated for the validation data, but RMSE doesn't keep information regarding the distribution of the anomaly score. It can give the same values for anomaly scores without obvious outliers and those with obvious outliers. Since the distribution of the anomaly score has an impact on anomaly detection accuracy, the metric based on the anomaly score should perform well for estimating the best combination of models.

The metric can be one of the maximum value of the anomaly score at validation data, a value determined by a peaks-over-threshold approach, a value determined by the inner-quartile range or sum of residuals between a threshold and anomaly score under the threshold. The metric can further be a sum of the above metrics for each region covered by the model.

In general, a model which fits well to the validation data performs well for anomaly detection. Similarly, a set of models fit to validation data will perform well for anomaly detection. Thus, the best set of models gives a lower sum of the performance metric. For embodiments where a lower performance metric indicates better performance, the objective function can be expressed as:

$$min {\sum }_{M} {l}^{( m )} {x}^{( ( m ) )}$$

such that Σ_{M}wᵢⱼ^{(m)}x^{(m)}=1 and

$${w}_{i j}^{( m )} = \{ \begin{matrix}1 {m}^{th} model occupies region i , j \\ 0 otherwise\end{matrix}$$

where l^{(m)} is a performance metric value of the m^{th} model, wᵢⱼ^{(m)} is an occupancy indicator of the m^{th} model for the i^{th} sensor group and i^{th} operational mode, and x^{(m)}∈{0,1} is an indicator of selecting the m^{th} model.

The approximated solution to this optimization can be determined using a branch and bound approach. If fewer models are preferable, the optimization problem may be modified as:

$$min {\sum }_{M} {l}^{( m )} {x}^{( m )} + λ {\sum }_{M} {x}^{( m )}$$

where λ is a hyper-parameter.

Block 212 identifies a best combination of sensor groups, according to the performance metric. A second metric may be used to identify the best combination of models. Given a set of models associated with the best performance metric value, the best combination of regions may be determined, such that a set of models corresponding to the regions covers all sensor groups and operational modes to be mutually exclusive and collectively exhaustive. Block 214 performs fine tuning on the set of models, for example using additional training data and training iterations.

Domain-specific fine tuning is used to transfer learning from the entire regions covered by the root model to a leaf model that covers a sub-set of regions. While the root model as a whole can be adapted with fine-tuning to be one of the leaf models covering all of the sensor groups, the root model may be decomposed for the leaf models which partially cover all of the sensor groups.

Leaf models may have the same model architecture as the root model, including networks of the first time and a network of the second type. Since the networks of the first type are independent and separable for each sensor group, root model networks may be extracted to form the leaf model for the selected sensor groups. Parameters for the network of the second type (e.g., a fully connected layer) may be selected according to selected sensor groups, as a the second-type network may be represented as a square matrix, where each row of the matrix may be used to compute an output value for a respective sensor. Each column of the matrix may be multiplied by a value of a respective sensor. The rows and columns for the selected sensor groups may be extracted to obtain the second-type network for the leaf model. Corresponding parameters in the root model may be used as initial values for transfer learning. This can be extended to cases where the second-type network has intercept terms.

The loss function for a leaf model may be defined as:

$${L}_{l e a f} = \frac{1}{K} {\sum }_{i = 1}^{K} {L}_{i}$$

where Lᵢ=∥\hat{X}⁽ⁱ⁾−X⁽ⁱ⁾∥₂² and where K is the number of time series segments in a mini batch. During learning of the leaf model, the MSE of the reconstruction by the entire model may be computed with validation data, and parameters with the minimum MSE may be retained. Detection performance may be estimated with validation data.

Threshold values may be used as surrogate metrics for detection performance. The threshold values may be computed for each region covered by a leaf model and summed, so that they are fairly comparable between leaf models. With the threshold value tᵢⱼ for the region (i,j), the detection score of the m^{th} leaf model s_{d}^{(m)} may be defined as:

$${s}_{d}^{( m )} = - {\sum }_{< i , j >} {t}_{i j}$$

where <i,j> represents a set of regions covered by the leaf model. Interquartile range may be used to calculate these values, as it provides a relatively stable estimate with a small number of samples and computes threshold values based on values around the central part of a distribution.

Penalty scores can be interpreted as a hyper-parameter, balancing between performance of models and complexity. The value may be determined automatically, assuming the detection score of the optimal set of models is better than the score corresponding to linear improvement with respect to the number of models. The best set may be obtained as the solution of 1 setting zero to the penalty score. The simplest set just includes the root model.

The term s_{db} represents the detection score by the empirically best set, the term N_{b} represents the number of models in the empirically best set, and s_{ds} represents the detection score by the simplest set. The penalty score λ may be defined as:

$$λ = ( 1 + ε ) \frac{{s}_{d b} - {s}_{d s}}{{N}_{b} - 1 ( 1 + ε )}$$

where ε is a small value that ensures the detection score of the optimal set of models is better than interpolated values between the empirical best set and the simplest set.

If model merging is used to train the models in block 208, an LSTM auto-encoder model is trained for each sensor group as the source models and are adapted to regions of interest, merging the pre-trained models. To obtain a model that covers multiple sensor groups, the pre-trained models for the corresponding sensor groups may be used to obtain initial values at adaptation. Weights in each of the projection layers can be represented as a matrix, since the projection layers apply the same transformation over the temporal dimension.

The reconstructed values of the j^{th} time point in Xᵢ may be represented as:

\hat{x}ᵢⱼ−Wᵢhᵢⱼ

where Wᵢ is a weight matrix at the projection layer for the i^{th} sensor group, and hᵢⱼ is the feature vector of the j^{th} time in Xᵢ, which is a subset of the outputs of the decoder Dᵢ. Given a set of weight matrices in projection layers from sensor groups of interest, a block matrix may be formed by placing the weight matrices in the diagonal elements. The block matrix may be used as the projection layer for the model covering the sensor groups of interest. Non-diagonal elements in the block matrix may be initialized with a Glorot initialization.

With Xₛ being the time series segment of the sensor groups of interest, then Wₛ is the block matrix and hⱼ is the feature vector of the j^{th} time point in Xₛ, which may be obtained as a concatenation of feature vectors from decoders for sensor groups of interest. The reconstruction may then be defined as:

\hat{x}ⱼ=Wₛhⱼ

In this manner, weights in pre-trained models may be fully utilized, even if the new model covers multiple sensor groups. The weights may be used as initial values of parameters in the model at adaptation. In the new model covers a sensor group, but is adapted to a subset of all operational modes, weights in the model of the corresponding sensor group may be used as initial values of parameters in the model at adaptation.

If model decomposition is used to train the models in block 208, a source model based on multiple LSTM auto-encoders is trained for all sensor groups and is then adapted to regions of interest, decomposing the pre-trained model. Given Nₛ sensor groups, the initial model will include Nₛ LSTM auto-encoders, connected with a projection layer.

With Xₐ being the time series segment for all sensor groups, the term W_{d} may be the weight matrix at the projection layer, yⱼ may be an output vector of the j^{th} time point in Xₐ, which may be obtained as a concatenation of outputs for the j^{th} time point from all Pᵢ. The reconstructed value of the j^{th} time point in Xₐ may be expressed as:

\hat{x}ⱼ=W_{d}yᵢ

To prevent negative transfer at adaptation, an additional loss term may be incorporated into the loss function at the training of the source model. With xᵢⱼₖ being the observation vector for the i^{th} sensor group at the j^{th} time stamp, in the k^{th} time series segment in the mini-batch, the term G₁ represents the RMSE of the LSTM auto-encoder for the i^{th} sensor group and yᵢⱼₖ is the reconstructed values from the LSTM auto-encoder for the i^{th} sensor group. The loss function may be defined as:

$$L = \sum {L}_{i} + \sum {G}_{i} \\ where \\ {G}_{i} = \frac{1}{K} {‖ {x}_{i j k} - {y}_{i j k} ‖}_{2}^{2}$$

and where K is the number of time series segments in the mini-batch.

Part of the model architecture of the source model may be used as the model architecture for a set of sensor groups of interest. Given Nₛₛ sensor groups of interest, the model for sensor groups of interest may include the set of corresponding LSTM auto-encoders and a projection layer. Since the model is a part of the source model, the source model has corresponding weights of the model for sensor groups of interest. The values of the corresponding weights may be used as the initial value of parameters at adaptation.

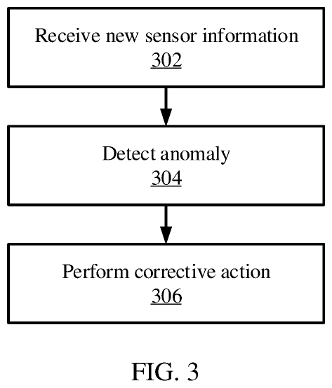

Referring now to FIG. 3, a method of detecting and responding to anomalies is shown. Block 302 receives new time series information from the sensors 104. This new time series information may reflect a present state of the system, and may include sensor measurements as well as information about the system's operational state.

Block 304 determines that the new time series information represents anomalous behavior. One or more models corresponding to the sensors that provided the new time series information may be used to process the new time series information, with the model(s) outputting an anomaly score. Block 304 may compare the anomaly score to a threshold, with above-threshold values indicating the presence of an anomaly.

Block 304 may compute an anomaly score based on reconstruction errors. To keep model sensitivity high, reconstruction errors may be used form the latest time within a time series segment. The term x^{(t)} represents the latest observations at the i^{th} time series segment and \hat{x}^{(t)} represents the reconstruction. The anomaly score may be defined as:

$${a}_{t} = \frac{1}{D} {‖ {\hat{x}}^{( t )} - {x}^{( t )} ‖}_{2}^{2}$$

where D is a number of dimensions at the output.

The threshold value for identifying an anomaly may be determined with validation, for example using a peaks-over-threshold approach, which fits the tail portion of a probability distribution by a generalized pareto distribution. This distribution may be defined for high extreme values as:

$$F ( a ) = P ( A - t h > a \vert A > t h ) ∼ {( 1 + \frac{γ a}{β} )}^{- \frac{1}{γ}}$$

where th is the initial threshold for anomaly scores, γ and β are the shape parameter and the scale parameter of the distribution respectively, and a is a value of the anomaly score. The portion below the threshold, A−th, is empirically set to a low quantile, where A represents anomaly scores and a is a value of A. For example, A may represent anomaly scores from the validation data, but may also include scores from the training data as well. The final threshold may be computed as:

$${z}_{q} = t h + \frac{\hat{β}}{\hat{γ}} ( {( \frac{q n}{{N}_{th}} )}^{- \hat{γ}} - 1 )$$

where q is the desired probability, n is the total number of anomaly scores, and Nₜₕ is the number of peaks (e.g., the number aₜ such that a>th). The parameters \hat{γ} and \hat{σ} may be estimated by maximum likelihood estimation.

Block 306 performs a corrective action. The corrective action can include diagnostics designed to acquire more information regarding the anomaly from the sensors 104. The corrective action can include sending an instruction to one or more sub-systems of the monitored system 102, to bring the sensor readings back to a “normal” state.

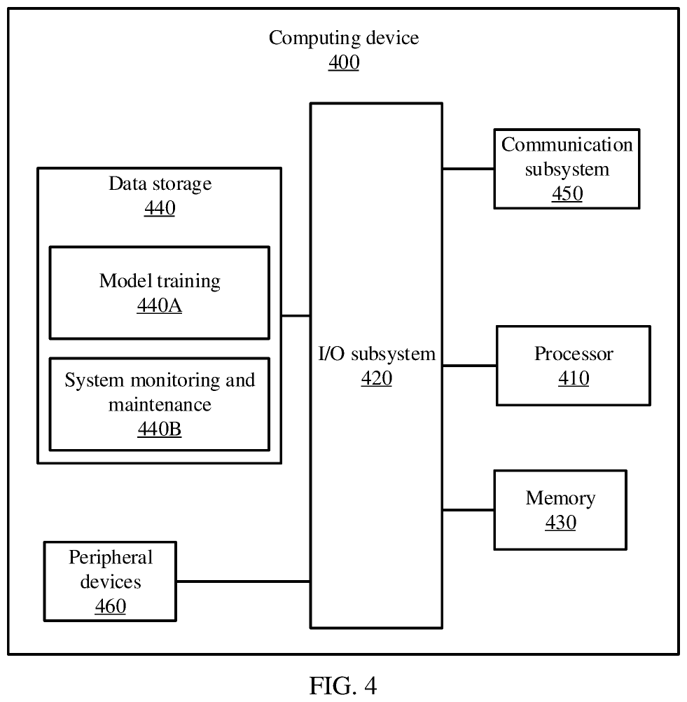

Referring now to FIG. 4, an exemplary computing device 400 is shown, in accordance with an embodiment of the present invention. The computing device 400 is configured to perform classifier enhancement.

The computing device 400 may be embodied as any type of computation or computer device capable of performing the functions described herein, including, without limitation, a computer, a server, a rack based server, a blade server, a workstation, a desktop computer, a laptop computer, a notebook computer, a tablet computer, a mobile computing device, a wearable computing device, a network appliance, a web appliance, a distributed computing system, a processor-based system, and/or a consumer electronic device. Additionally or alternatively, the computing device 400 may be embodied as a one or more compute sleds, memory sleds, or other racks, sleds, computing chassis, or other components of a physically disaggregated computing device.

As shown in FIG. 4, the computing device 400 illustratively includes the processor 410, an input/output subsystem 420, a memory 430, a data storage device 440, and a communication subsystem 450, and/or other components and devices commonly found in a server or similar computing device. The computing device 400 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 430, or portions thereof, may be incorporated in the processor 410 in some embodiments.

The processor 410 may be embodied as any type of processor capable of performing the functions described herein. The processor 410 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 430 may be embodied as any type of volatile or non-volatile memory or data storage capable of performing the functions described herein. In operation, the memory 430 may store various data and software used during operation of the computing device 400, such as operating systems, applications, programs, libraries, and drivers. The memory 430 is communicatively coupled to the processor 410 via the I/O subsystem 420, which may be embodied as circuitry and/or components to facilitate input/output operations with the processor 410, the memory 430, and other components of the computing device 400. For example, the I/O subsystem 420 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 420 may form a portion of a system-on-a-chip (SOC) and be incorporated, along with the processor 410, the memory 430, and other components of the computing device 400, on a single integrated circuit chip.

The data storage device 440 may be embodied as any type of device or devices configured for short-term or long-term storage of data such as, for example, memory devices and circuits, memory cards, hard disk drives, solid state drives, or other data storage devices. The data storage device 440 can store program code 440A for model training and program code 440B for system monitoring and maintenance. The communication subsystem 450 of the computing device 400 may be embodied as any network interface controller or other communication circuit, device, or collection thereof, capable of enabling communications between the computing device 400 and other remote devices over a network. The communication subsystem 450 may be configured to use any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 400 may also include one or more peripheral devices 460. The peripheral devices 460 may include any number of additional input/output devices, interface devices, and/or other peripheral devices. For example, in some embodiments, the peripheral devices 460 may include a display, touch screen, graphics circuitry, keyboard, mouse, speaker system, microphone, network interface, and/or other input/output devices, interface devices, and/or peripheral devices.

Of course, the computing device 400 may also include other elements (not shown), as readily contemplated by one of skill in the art, as well as omit certain elements. For example, various other sensors, input devices, and/or output devices can be included in computing device 400, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 400 are readily contemplated by one of ordinary skill in the art given the teachings of the present invention provided herein.

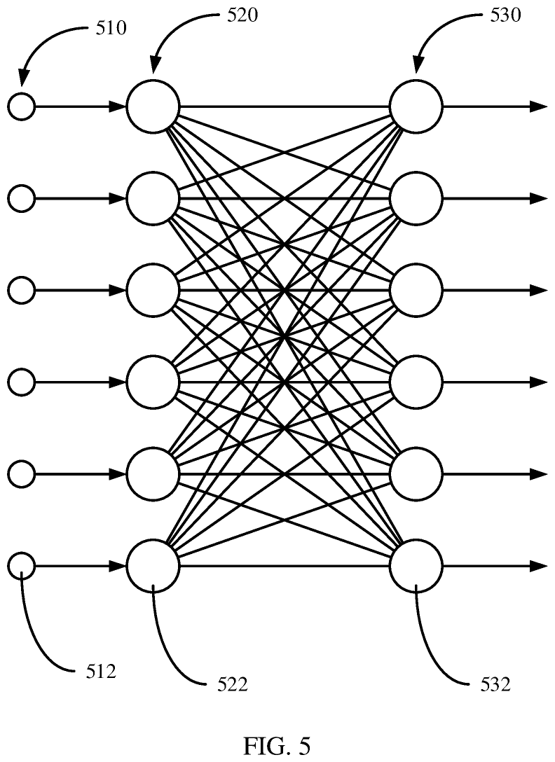

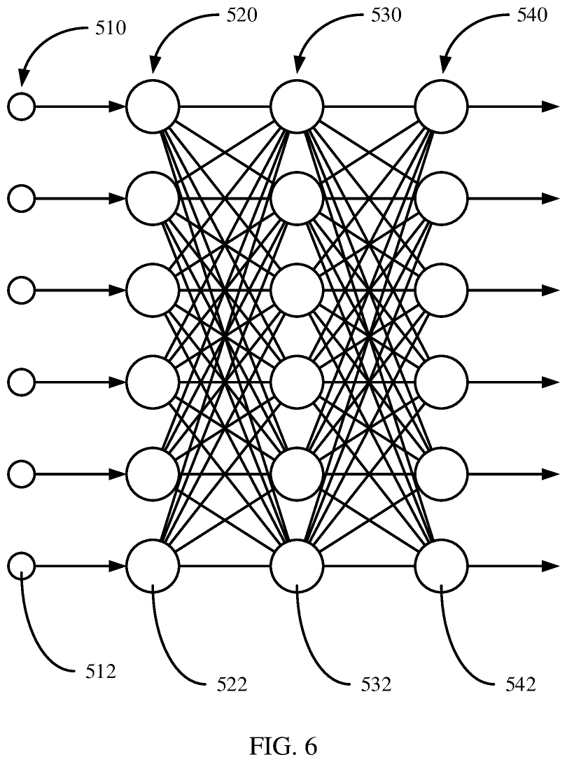

Referring now to FIGS. 5 and 6, exemplary neural network architectures are shown, which may be used to implement parts of the present models. A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the inputted data belongs to each of the classes can be outputted.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types, and may include multiple distinct values. The network can have one input node for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples, and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

In layered neural networks, nodes are arranged in the form of layers. An exemplary simple neural network has an input layer 520 of source nodes 522, and a single computation layer 530 having one or more computation nodes 532 that also act as output nodes, where there is a single computation node 532 for each possible category into which the input example could be classified. An input layer 520 can have a number of source nodes 522 equal to the number of data values 512 in the input data 510. The data values 512 in the input data 510 can be represented as a column vector. Each computation node 532 in the computation layer 530 generates a linear combination of weighted values from the input data 510 fed into input nodes 520, and applies a non-linear activation function that is differentiable to the sum. The exemplary simple neural network can perform classification on linearly separable examples (e.g., patterns).

A deep neural network, such as a multilayer perceptron, can have an input layer 520 of source nodes 522, one or more computation layer(s) 530 having one or more computation nodes 532, and an output layer 540, where there is a single output node 542 for each possible category into which the input example could be classified. An input layer 520 can have a number of source nodes 522 equal to the number of data values 512 in the input data 510. The computation nodes 532 in the computation layer(s) 530 can also be referred to as hidden layers, because they are between the source nodes 522 and output node(s) 542 and are not directly observed. Each node 532, 542 in a computation layer generates a linear combination of weighted values from the values output from the nodes in a previous layer, and applies a non-linear activation function that is differentiable over the range of the linear combination. The weights applied to the value from each previous node can be denoted, for example, by w₁, w₂, . . . wₙ₋₁, wₙ. The output layer provides the overall response of the network to the inputted data. A deep neural network can be fully connected, where each node in a computational layer is connected to all other nodes in the previous layer, or may have other configurations of connections between layers. If links between nodes are missing, the network is referred to as partially connected.

Training a deep neural network can involve two phases, a forward phase where the weights of each node are fixed and the input propagates through the network, and a backwards phase where an error value is propagated backwards through the network and weight values are updated.

The computation nodes 532 in the one or more computation (hidden) layer(s) 530 perform a nonlinear transformation on the input data 512 that generates a feature space. The classes or categories may be more easily separated in the feature space than in the original data space.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for training a neural network, comprising:
training a plurality of models for respective sensor groups in a cyber-physical system;
sampling combinations of sensor groups and operational modes;
training a combination model for each of the sampled combinations;
determining a best combination model based on performance measured during training; and
fine-tuning the best combination model.

2. The method of claim 1, wherein training the combination model includes model merging of the plurality of models.

3. The method of claim 2, wherein model merging of the plurality of models includes concatenating models of the plurality of models using a fully connected layer.

4. The method of claim 2, wherein model merging of the plurality of models includes initializing weights of a merged model with weight values of the plurality of models.

5. The method of claim 2, wherein each of the plurality of models includes a long-short term memory autoencoder model.

6. The method of claim 1, wherein training the combination model includes model decomposition of the plurality of models.

7. The method of claim 6, wherein decomposition of the plurality of models includes combining outputs of models of the plurality of models.

8. The method of claim 6, wherein the plurality of models are represented as long-short term memory auto-encoders connected with a projection layer in a source model.

9. The method of claim 1, wherein the operational modes each correspond to a different operational mode of the cyber-physical system.

10. The method of claim 1, further comprising detecting an anomaly using the fine-tuned best combination model and performing a corrective action responsive to the anomaly that is selected from the group consisting of changing a security setting for an application or hardware component, changing an operational parameter of an application or hardware component, halting and/or restarting an application, halting and/or rebooting a hardware component, changing an environmental condition, and changing a network interface's status or settings.

11. A method for training a neural network, comprising:
training a plurality of models for respective sensor groups in a cyber-physical system, each of the plurality of models including a long-short term memory auto-encoder;
sampling combinations of sensor groups and operational modes, each operational mode corresponding to a different operational mode of the cyber-physical system;
training a combination model for each of the sampled combinations using one of model merging and model decomposition;
determining a best combination model based on performance measured during training; and
fine-tuning the best combination model.

12. A system for training a neural network, comprising:
a hardware processor; and
a memory that includes a computer program, which, when executed by the hardware processor, causes the hardware processor to:
train a plurality of models for respective sensor groups in a cyber-physical system;
sample combinations of sensor groups and operational modes;
train a combination model for each of the sampled combinations;
determine a best combination model based on performance measured during training; and
fine-tune the best combination model.

13. The system of claim 12, wherein the computer program further causes the hardware processor to train the combination model using model merging of the plurality of models.

14. The system of claim 13, wherein the computer program further causes the hardware processor to concatenate models of the plurality of models using a fully connected layer.

15. The system of claim 13, wherein the computer program further causes the hardware processor to initialize weights of a merged model with weight values of the plurality of models.

16. The system of claim 13, wherein each of the plurality of models includes a long-short term memory autoencoder model.

17. The system of claim 12, wherein the computer program further causes the hardware processor to train the combination model using model decomposition of the plurality of models.

18. The system of claim 17, wherein decomposition of the plurality of models includes combining outputs of models of the plurality of models.

19. The system of claim 17, wherein the plurality of models are represented as long-short term memory auto-encoders connected with a projection layer in a source model.

20. The system of claim 12, wherein the operational modes each correspond to a different operational mode of the cyber-physical system.
